(19) United States
(12) Patent Application Publication
(10) Pub. No.: US 2026/0296111 A1
(43) Pub. Date: Oct. 1, 2026

(54) TIRE

(71) Applicant: The Yokohama Rubber Co., LTD., Kanagawa (JP)

(72) Inventor: Takafumi GOHARA, Kanagawa (JP)

(21) Appl. No.: 19/573,699

(22) Filed: Mar. 20, 2026

(30) Foreign Application Priority Data
Mar. 26, 2025 (JP) 2025-051120

(51) Int. Cl. B60C 11/13; B60C 9/20; B60C 11/03

(52) U.S. Cl. CPC B60C 11/1353; B60C 9/20; B60C 2009/2012; B60C 2011/0341; B60C 2011/1361

(57) ABSTRACT

A tire that can provide improved belt durability while providing ensured stone drilling resistance. A belt layer including a pair of cross belt layers and a circumferential reinforcing layer in which an inclination angle of belt cords in a tire width direction with respect to a tire circumferential direction is 5° or less. A tread portion includes at least one circumferential groove in a range in which the circumferential reinforcing layer is disposed in the tire width direction. In at least one circumferential groove, a projection portion projecting from a groove wall on at least one side into the circumferential groove is disposed. In the circumferential groove including the projection portion, a road contact surface-side cross-sectional area S1 and a groove bottom-side cross-sectional area S2 satisfy a relationship 0.1≤S2/S1≤0.7.

### CROSS-REFERENCE TO RELATED APPLICATION

This application claims priority pursuant to 35 U.S.C. 119(a) to Japanese Patent Application No. 2025-051120, filed Mar. 26, 2025, which application is incorporated herein by reference in its entirety.

### TECHNICAL FIELD

The present invention relates to a tire.

### BACKGROUND

A tire has a belt layer as a reinforcing layer in a tread portion. The tread portion has increased rigidity due to the belt layer, and performance of known tires has been improved by devising the belt layer. For example, in a tire described in Japanese Patent No. 10-250314, at least one circumferential belt layer formed of a reinforcing element extending along an equatorial plane of the tire is disposed on an inner side in a tire radial direction of a circumferential groove adjacent to a tire shoulder portion, and a projection extending toward an outer side in the tire radial direction is provided on a bottom portion of the circumferential groove. In a tire described in Japanese Patent Application No. 2001-0633151, a belt has two or more cord crossing layers near a carcass and two or more substantially inextensible circumferentially arranged cord layers on an outer circumferential side thereof.

### SUMMARY

### Technical Problem

In a tire of the related art, there is a problem that belt durability, which is durability against cracks and the like starting from a belt layer, is likely to deteriorate due to an increase in distortion of the belt layer caused by an increase in an outer diameter of the tire after traveling. As one of solutions to this problem, a technique of disposing a circumferential reinforcing layer to suppress an increase in the outer diameter and reduce distortion as in the tires described in Japanese Patent No. 10-250314 and Japanese Patent Application No. 2001-063315.

However, when the circumferential reinforcing layer is disposed, the ground contact length becomes short due to the increased rigidity of the tread portion, and in particular, the ground contact length of the shoulder region becomes short due to the shoulder region becoming difficult to contact the ground, so the load distribution of the center region in the tire width direction increases, and the ground contact pressure of the center region easily increases. When the ground contact pressure increases, the deformation of the groove formed in the tread portion increases upon contact of the tread with the ground. Thus, when a stone enters the groove and bites into the groove, a force pushing the stone toward a groove bottom side increases. Accordingly, there is a risk that so-called stone drilling in which the groove bottom is damaged due to the stone biting into the groove bottom is likely to occur. Therefore, improving the belt layer durability while suppressing the occurrence of stone drilling has been extremely difficult.

In light of the foregoing, an object of the present invention is to provide a tire that can provide improved belt durability while providing ensured stone drilling resistance. A belt layer includes a pair of cross belt layers and a circumferential reinforcing layer in which an inclination angle of belt cords in a tire width direction with respect to a tire circumferential direction is 5° or less. A tread portion includes at least one circumferential groove in a range in which the circumferential reinforcing layer is disposed in the tire width direction. In at least one circumferential groove, a projection portion projecting from a groove wall on at least one side into the circumferential groove is disposed. In the circumferential groove including the projection portion, a road contact surface-side cross-sectional area S1 and a groove bottom-side cross-sectional area S2 satisfy a relationship 0.1≤S2/S1≤0.7. In the tread portion, a ratio D0/W0 of a thickness D0 from a tread contact surface to the circumferential reinforcing layer to a width W0 of the circumferential reinforcing layer in the tire width direction is defined as a deformation potential of the tread portion, and the deformation potential is within a range 0.06≤Tp≤0.20.

### Solution to Problem

To solve the problems described above and achieve the object, a tire according to an embodiment of the present invention is a tire including a belt layer that is disposed in a tread portion and includes a plurality of belt plies. The belt layer includes a pair of cross belt layers in which inclination directions of belt cords in a tire width direction with respect to a tire circumferential direction are opposite to each other, and a circumferential reinforcing layer in which an inclination angle of the belt cords in the tire width direction with respect to the tire circumferential direction is 5° or less, the tread portion includes at least one circumferential groove extending in the tire circumferential direction in a range in which the circumferential reinforcing layer is disposed in the tire width direction. In at least one circumferential groove of the at least one circumferential groove, a projection portion projecting from a groove wall on at least one side into the circumferential groove and connected to a groove bottom is disposed. In the circumferential groove including the projection portion, a road contact surface-side cross-sectional area S1, which is a cross-sectional area from a tread contact surface to a position corresponding to one-half of a groove depth in the circumferential groove, and a groove bottom-side cross-sectional area. S2, which is a cross-sectional area from the position corresponding to one-half of the groove depth from the tread contact surface to the groove bottom, satisfy a relationship 0.1≤S2/S1≤0.7. In the tread portion, a ratio D0/W0 of a thickness D0 from the tread contact surface to the circumferential reinforcing layer to a width W0 of the circumferential reinforcing layer in the tire width direction is defined as a deformation potential Tp of the tread portion, and the deformation potential Tp is within a range 0.06≤Tp≤0.20.

### Advantageous Effects of Invention

The tire according to an embodiment of the present invention has the effect that can provide improved belt durability while providing ensured stone drilling resistance.

### BRIEF DESCRIPTION OF DRAWINGS

FIG. 1 is a tire meridian cross-sectional view illustrating a main portion of a pneumatic tire according to an embodiment;

FIG. 2 is a schematic diagram illustrating a belt layer illustrated in FIG. 1;

FIG. 3 is a detailed view of a tread portion illustrating a region on one side from a tire equatorial plane in a tire width direction of the tread portion illustrated in FIG. 1;

FIG. 4 is a schematic diagram of a cross-section of a circumferential groove as viewed in an extension direction of the circumferential groove;

FIG. 5 is a schematic diagram of a cross-section of the circumferential groove as viewed in the extension direction of the circumferential groove;

FIG. 6 is a schematic diagram of a cross-section of the circumferential groove as viewed in the extension direction of the circumferential groove;

FIG. 7 is an explanatory diagram of dimensions of a projection portion of the circumferential groove illustrated in FIG. 4;

FIG. 8 is an explanatory diagram of dimensions of a projection portion of the circumferential groove illustrated in FIG. 5;

FIG. 9 is an explanatory diagram of a profile drop amount of a tread contact surface;

FIG. 10 is an explanatory diagram of an aspect where projection portions are alternately disposed on groove walls on both sides of the circumferential groove, illustrating a modified example of a pneumatic tire according to an embodiment;

FIG. 11 is an explanatory diagram of an aspect where projection portions are alternately disposed on groove walls on both sides of the circumferential groove, illustrating a modified example of a pneumatic tire according to an embodiment;

FIG. 12A is a table showing results of performance evaluation tests of pneumatic tires; and,

FIG. 12B is a table showing results of performance evaluation tests of pneumatic tires.

### DESCRIPTION OF EMBODIMENTS

Embodiments according to the present invention will be described in detail below with reference to the drawings. However, the invention is not limited to the embodiments. Constituents of the embodiments include elements that are substitutable while maintaining consistency with the invention and obviously substitutable elements. The plurality of modified examples described in the embodiments can be combined as desired within the scope apparent to one skilled in the art.

In the following description, a description will be given using a pneumatic tire 1 as an example of the tire according to the embodiments of the present invention. The pneumatic tire 1 as an example of the tire can be inflated with any gas including air and inert gas, such as nitrogen.

In the following description, the term “tire radial direction” refers to a direction orthogonal to the tire rotation axis (not illustrated), which is a rotation axis of a pneumatic tire 1, the term “inner side in the tire radial direction” refers to a side toward the tire rotation axis in the tire radial direction, and the term “outer side in the tire radial direction” refers to a side away from the tire rotation axis in the tire radial direction of an embodiment. The term “tire circumferential direction” refers to a circumferential direction with the tire rotation axis as a center axis. The term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The term “tire equator line” refers to a line in the tire circumferential direction of the pneumatic tire 1 that lies on the tire equatorial plane CL. The term “cross-section in the tire meridian direction (meridian cross-sectional view)” refers to a cross section of the tire taken along a plane that includes the tire rotation axis.

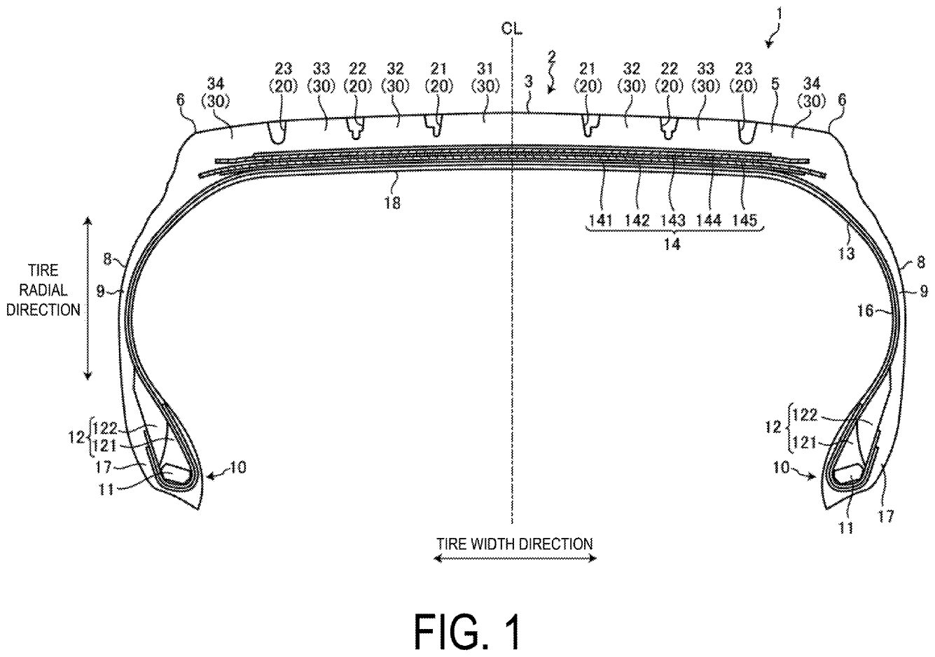

FIG. 1 is a tire meridian cross-sectional view illustrating a main portion of the pneumatic tire 1 according to an embodiment. FIG. 1 illustrates a meridional cross section of the pneumatic tire 1 according to an embodiment, the cross section of one side region of a tire rotation axis in a tire radial direction. In the present embodiment, a heavy duty pneumatic radial tire mounted on a long-distance transport vehicle such as a truck or bus will be described as an example.

In the pneumatic tire 1 according to the present embodiment, a tread portion 2 is disposed on a portion on the outermost side in the tire radial direction when viewed in a tire meridian cross-section, and the tread portion 2 includes a tread rubber 5 made of a rubber composition. A surface of the tread portion 2, that is, a portion that comes into contact with road surfaces during traveling of a vehicle (not illustrated) on which the pneumatic tires 1 are mounted is formed as a tread contact surface 3, and the tread contact surface 3 forms a portion of a contour of the pneumatic tire 1.

A plurality of circumferential grooves 20 extending in the tire circumferential direction are disposed in the tread contact surface 3 in the tread portion 2, and a plurality of land portions 30 are defined by the plurality of circumferential grooves 20 on the surface of the tread portion 2. In the present embodiment, the circumferential grooves 20 include six grooves of two center main grooves 21 disposed on both sides of the tire equatorial plane CL in the tire width direction with the tire equatorial plane CL interposed therebetween, two middle main grooves 22, one disposed on an outer side in the tire width direction of each of the two center main grooves 21, and two shoulder main grooves 23, one disposed on an outer side in the tire width direction of each of the two middle main grooves 22.

The circumferential groove 20 referred to herein is a longitudinal groove extending in the tire circumferential direction and internally having a wear indicator (slip sign) indicative of a terminal stage of wear. The circumferential grooves 20 formed in the above-described manner have a groove width within a range of 9 mm or more and 17 mm or less, and a groove depth within a range of 12 mm or more and 21 mm or less.

The land portion 30 defined by the circumferential groove 20 includes a center land portion 31, first middle land portions 32, second middle land portions 33, and shoulder land portions 34. Among these, the center land portion 31 is the land portion 30 located between the center main grooves 21, and both sides thereof in the tire width direction are defined by the center main grooves 21.

The first middle land portion 32 is the land portion 30 located between the center main groove 21 and the middle main groove 22 adjacent in the tire width direction, and the land portion 30 has both sides in the tire width direction defined by the center main groove 21 and the middle main groove 22. That is, a portion on an inner side in the tire width direction of the first middle land portion 32 is defined by the center main groove 21, and a portion on an outer side in the tire width direction of the first middle land portion 32 is defined by the middle main groove 22. The second middle land portion 33 is the land portion 30 located between the middle main groove 22 and the shoulder main groove 23 adjacent in the tire width direction, and the land portion 30 has both sides in the tire width direction defined by the middle main groove 22 and the shoulder main groove 23. That is, a portion on an inner side in the tire width direction of the second middle land portion 33 is defined by the middle main groove 22, and a portion on an outer side in the tire width direction of the second middle land portion 33 is defined by the shoulder main groove 23.

The shoulder land portion 34 is the land portion 30 located on an outer side in tire width direction of the shoulder main groove 23, and an inner side thereof in the tire width direction is defined by the shoulder main groove 23. The first middle land portions 32, the second middle land portions 33, and the shoulder land portions 34 are disposed on both sides in the tire width direction of the tire equatorial plane CL, respectively.

Shoulder portions 6 are located at ends on both outer sides in the tire width direction of the tread portion 2 formed as described above, and sidewall portions 8 are disposed on inner sides in the tire radial direction of the shoulder portions 6. That is, the sidewall portions 8 are disposed on both sides in the tire width direction of the tread portion 2. In other words, the sidewall portions 8 are disposed at two sections on both sides in the tire width direction of the pneumatic tire 1 and form portions exposed to the outermost sides in the tire width direction of the pneumatic tire 1. The sidewall portion 8 includes a sidewall rubber 9 made of a rubber composition.

A bead portion 10 is provided on an inner side in the tire radial direction of each of the sidewall portions 8 located on both sides in the tire width direction. As with the sidewall portions 8, the bead portions 10 are disposed at two sections on both sides of the tire equatorial plane CL. That is, a pair of the bead portions 10 is disposed on both sides in the tire width direction of the tire equatorial plane CL. The bead portions 10 each include a bead core 11, and a bead filler 12 is provided on an outer side in the tire radial direction of the bead core 11.

The bead core 11 is an annular member formed in an annular shape by bundling bead wires, which are steel wires, and winding them multiple times. The bead fillers 12 include a lower filler 121 and an upper filler 122, which are rubber members, are respectively disposed on outer sides in the tire radial direction of the bead cores 11, and reinforce the bead portions 10.

A carcass layer 13 containing cords of radial plies is continuously provided on an inner side in the tire radial direction of the tread portion 2 and on the tire equatorial plane CL side of the sidewall portions 8. Accordingly, the pneumatic tire 1 according to the present embodiment is configured as a so-called radial tire. The carcass layer 13 has a single layer structure made of one carcass ply or a multilayer structure made of a plurality of carcass plies layered, and extends in a toroidal shape between the pair of bead portions 10 disposed on both sides in the tire width direction to constitute a backbone of the tire.

Specifically, the carcass layer 13 is disposed to extend from one bead portion b to the other bead portion 10 of the pair of bead portions 10 located on both sides in the tire width direction and is turned back toward the outer sides in the tire width direction along the bead cores 11 at the bead portions 10 so as to wrap around the bead cores 11 and the bead fillers 12. The bead filler 12 is a rubber member disposed in a space on the outer side in the tire radial direction of the bead core 11, the space being formed by folding the carcass layer 13 back at the bead portion 10. The carcass ply of the carcass layer 13 is made by covering, with a coating rubber, a plurality of carcass cords made of steel or an organic fiber material such as aramid, nylon, polyester, or rayon and performing a rolling process thereon. The plurality of carcass cords forming the carcass ply are disposed in parallel at an angle in the tire circumferential direction, the angle with respect to the tire circumferential direction being along a tire meridian direction.

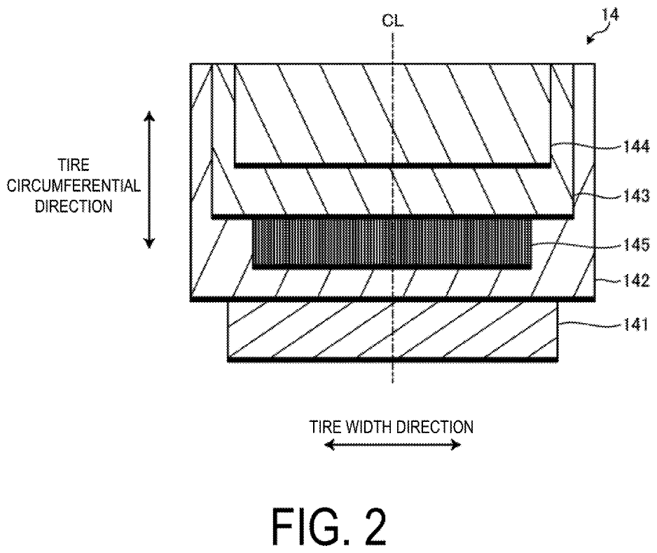

A belt layer 14 is disposed in the tread portion 2. FIG. 2 is a schematic diagram illustrating the belt layer 14 illustrated in FIG. 1. The belt layer 14 is disposed on the outer side in the tire radial direction of a portion, located in the tread portion 2, of the carcass layer 13 extending between the pair of bead portions 10. The belt layer 14 is formed by layering a plurality of belt plies 141 to 145 and is disposed around an outer circumference of the carcass layer 13. The belt plies 141 to 145 include a large-angle belt layer 141, a pair of cross belt layers 142 and 143, a belt cover 144, and a circumferential reinforcing layer 145.

The large-angle belt layer 141 is formed by covering a plurality of belt cords made of steel wire with a coating rubber and performing a rolling process thereon and has a cord angle (defined as an inclination angle in a longitudinal direction of the belt cord with respect to the tire circumferential direction) in absolute value of 45° or more and 70° or less, preferably 54° or more and 68° or less. The large-angle belt layer 141 is disposed in a layered manner on an outer side in the tire radial direction of the carcass layer 13.

The pair of cross belt layers 142 and 143 are formed by covering a plurality of belt cords made of steel with a coating rubber and performing a rolling process thereon, and have a cord angle in absolute value of 10° or more and 70° or less, preferably 10° or more and 45° or less. The pair of cross belt layers 142 and 143 have cord angles having mutually opposite signs and are layered by making the belt cords mutually intersect in the longitudinal direction of the belt cords (a so-called crossply structure is formed). That is, the pair of cross belt layers 142 and 143 have inclination directions of the belt cords in the tire width direction with respect to the tire circumferential direction that are opposite to each other. The pair of cross belt layers 142 and 143 are disposed in a layered manner on an outer side in the tire radial direction of the large-angle belt layer 141. Here, the cross belt layer 142 located on the inner side in the tire radial direction is defined as an inner cross belt layer 142, and the cross belt layer 143 located on the outer side in the tire radial direction is defined as an outer cross belt layer 143.

The belt cover 144 is formed by covering a plurality of belt cover cords made of steel wire or an organic fiber material with a coating rubber and performing a rolling process thereon, and has a cord angle in absolute value of 10° or more and 45° or less, preferably 14° or more and 28° or less. The belt cover 144 is disposed in a layered manner on an outer side in the tire radial direction of the cross-belt layers 142 and 143. Note that, in the present embodiment, the belt cover 144 has the same cord angle as that of the outer cross belt layer 143 and is disposed in the outermost layer of the belt layer 14.

The circumferential reinforcing layer 145 is formed by spirally winding a belt cord made of steel wire covered with a coating rubber in the tire circumferential direction, and has a cord angle in absolute value of 5° or less. That is, the circumferential reinforcing layer 145 has an inclination direction of the belt cords in the tire width direction with respect to the tire circumferential direction of 5° or less. The circumferential reinforcing layer 145 is disposed in a sandwiched manner between the pair of cross belt layers 142 and 143. The circumferential reinforcing layer 145 is formed with a width in the tire width direction that is narrower than widths of the cross-belt layers 142 and 143 in the tire width direction. Therefore, the circumferential reinforcing layer 145 is disposed on an inner side in the tire width direction with respect to end portions on both sides in the tire width direction of the pair of cross belt layers 142 and 143. Specifically, the circumferential reinforcing layer 145 is formed by spirally winding one or a plurality of wires on the outer circumference of the inner cross belt layer 142. The circumferential reinforcing layer 145 is continuously disposed in the tire width direction, extending across the tire equatorial plane CL in the tire width direction.

In the present embodiment, the circumferential reinforcing layer 145 has a number of ends of the belt cords, that is, a cord count of the belt cords per unit width, within a range of 15 cords/50 mm or more and 30 cords/50 mm or less. An outer diameter of the belt cord is within a range of 1.2 mm or more and 2.2 mm or less. Note that in a configuration in which the belt cord is made of a plurality of cords twisted together, a diameter of a circumscribed circle of the belt cord is measured as the outer diameter of the belt cord.

At the bead portion 10, a rim cushion rubber 17 that forms a contact surface of the bead portion 10 with respect to a rim flange is disposed on the inner side in the tire radial direction and the outer side in the tire width direction of the bead core 11 and a turned back portion of the carcass layer 13. An inner liner 16 is formed along the carcass layer 13 on the inner side of the carcass layer 13 or on the inner portion side of the carcass layer 13 in the pneumatic tire 1. The inner liner 16 forms a tire inner surface 18 that is a surface on the inner side of the pneumatic tire 1.

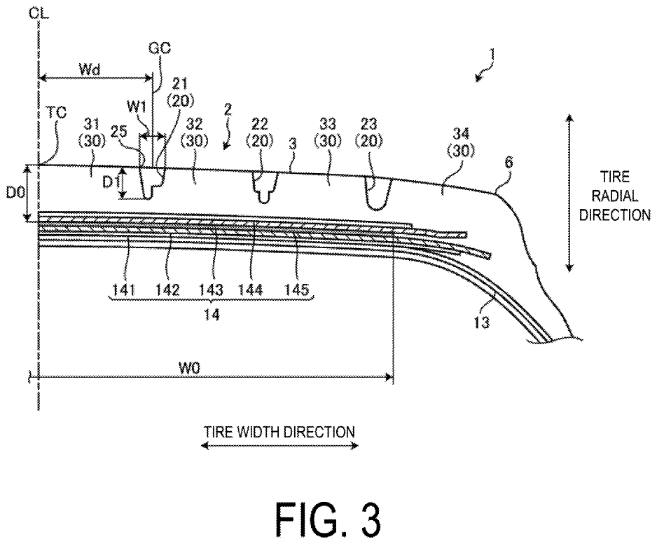

FIG. 3 is a detailed view of the tread portion 2 illustrating a region on one side from the tire equatorial plane CL in the tire width direction of the tread portion 2 illustrated in FIG. 1. At least one circumferential groove 20 disposed in the tread portion 2 is disposed in a range in which the circumferential reinforcing layer 145 is disposed in the tire width direction. In the present embodiment, all of the six circumferential grooves 20 disposed in the tread portion 2 are disposed in a range in which the circumferential reinforcing layer 145 is disposed in the tire width direction.

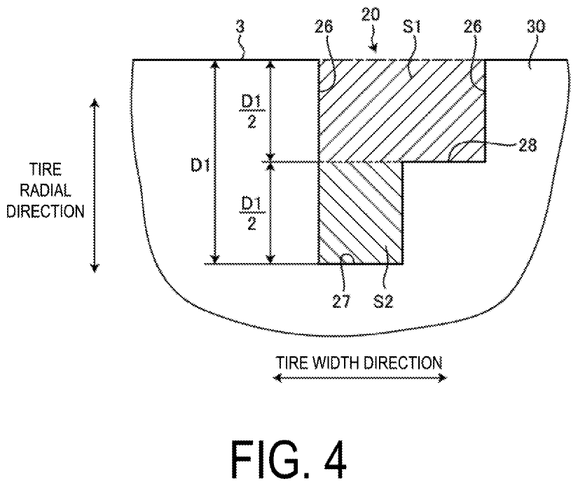

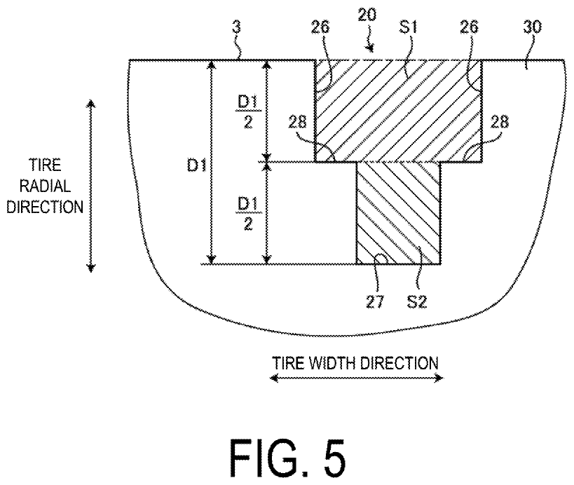

FIGS. 4 and 5 are schematic diagrams of cross-sections of the circumferential groove 20 as viewed in the extension direction of the circumferential groove 20. A projection portion 28 is disposed in at least one circumferential groove 20 among the circumferential grooves 20 disposed in a range in which the circumferential reinforcing layer 145 is disposed in the tire width direction. The projection portion 28 disposed in the circumferential groove 20 is formed to project into the groove from at least one groove wall 26 of groove walls 26 on both sides in a groove width direction of the circumferential groove 20 and to be connected to a groove bottom 27.

The projection portion 28 disposed in the circumferential groove 20 may be formed to project into the groove from one groove wall 26 of the groove walls 26 on both sides in the groove width direction of the circumferential groove 20 as illustrated in FIG. 4, or may be formed to project into the groove from the groove walls 26 on both sides in the groove width direction of the circumferential groove 20 as illustrated in FIG. 5, for example. In the circumferential groove 20 in which the projection portion 28 is disposed, the projection portion 28 is not disposed at least within a range of 40% of a groove depth D1 of the circumferential groove 20 from the tread contact surface 3 side, and the projection portion 28 is disposed on the groove bottom 27 side with respect to a portion corresponding to 40% of the groove depth D1 of the circumferential groove 20 from the tread contact surface 3 side.

In the present embodiment, the center main groove 21 is formed with the projection portion 28 projecting into the groove from the groove wall 26 on one side as illustrated in FIG. 4, and the middle main groove 22 is formed with the projection portion 28 projecting into the groove from the groove walls 26 on both sides as illustrated in FIG. 5. On the other hand, in the present embodiment, the projection portion 28 is not disposed in the shoulder main groove 23.

Among the plurality of circumferential grooves 20 disposed in the tread portion 2, the circumferential groove 20 having the projection portion 28 satisfies the relationship 0.1≤S2/S1≤0.7 where S1 is a road contact surface-side cross-sectional area, which is a cross-sectional area from the tread contact surface 3 to a position corresponding to one-half of the groove depth D1 in the circumferential groove 20, and S2 is a groove bottom-side cross-sectional area, which is a cross-sectional area from the position corresponding to one-half of the groove depth from the tread contact surface 3 to the groove bottom 27. That is, in the circumferential groove 20 having the projection portion 28, the projection portion 28 is disposed on the groove bottom 27 side in the groove depth direction of the circumferential groove 20, and thus the groove bottom-side cross-sectional area S2, which is a cross-sectional area on the side where the projection portion 28 is disposed, is smaller than the road contact surface-side cross-sectional area S1, which is a cross-sectional area on the side including a portion where the projection portion 28 is not disposed.

The road contact surface-side cross-sectional area S1 and the groove bottom-side cross-sectional area S2 are cross-sectional areas when the circumferential groove 20 is viewed in the extension direction of the circumferential groove 20, that is, cross-sectional areas of the circumferential groove 20 in the tire meridian cross-section of the pneumatic tire 1. The relationship between the road contact surface-side cross-sectional area S1 and the groove bottom-side cross-sectional area S2 of the circumferential groove 20 having the projection portion 28 is preferably within the range 0.3≤S2/S1≤0.6.

Note that the road contact surface-side cross-sectional area S1 and the groove bottom-side cross-sectional area S2 of the circumferential groove 20 are measured in a tire meridian cross-section in an unloaded state in which the tire is mounted on a specified rim and inflated to a specified internal pressure. The same applies to other dimensions described in the present specification unless otherwise specified. “Specified rim” refers to a “standard rim” defined by JATMA, a “Design Rim” defined by the Tire and Rim Association, Inc. (TRA), or a “Measuring Rim” defined by the European Tyre and Rim Technical Organisation (ETRTO). “Specified internal pressure” refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. A specified load refers to a “maximum load capacity” specified by JATMA, the maximum value in “TIRE LOAD LIMITS AT VARIOUS COLD INFLATION PRESSURES” specified by TRA, or “LOAD CAPACITY” specified by ETRTO.

Although FIGS. 4 and 5 illustrate that the position corresponding to one-half of the groove depth D1 from the tread contact surface 3 in the circumferential groove 20 is the same as a position of an end portion of the projection portion 28 on the outer side in the tire radial direction, the position of the end portion of the projection portion 28 on the outer side in the tire radial direction may be different from the position corresponding to one-half of the groove depth D1 from the tread contact surface 3 in the circumferential groove 20.

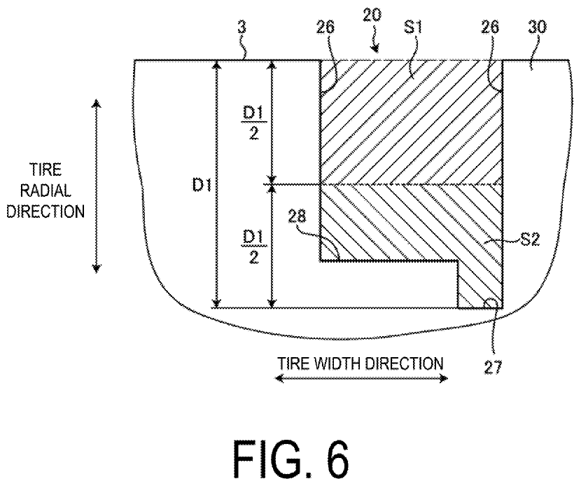

FIG. 6 is a schematic diagram of a cross-section of the circumferential groove 20 as viewed in the extension direction of the circumferential groove 20. The projection portion 28 disposed in the circumferential groove 20 may be disposed, for example, on the groove bottom 27 side with respect to the position corresponding to one-half of the groove depth D1 from the tread contact surface 3 in the circumferential groove 20, as illustrated in FIG. 6. In this case as well, regarding the road contact surface-side cross-sectional area S1 and the groove bottom-side cross-sectional area S2, regardless of the position of the projection portion 28 in the groove depth direction, a cross-sectional area from the tread contact surface 3 to a position corresponding to one-half of the groove depth D1 in the circumferential groove 20 is the road contact surface-side cross-sectional area S1, and a cross-sectional area from the position corresponding to one-half of the groove depth from the tread contact surface 3 to the groove bottom 27 is the groove bottom-side cross-sectional area S2.

The road contact surface-side cross-sectional area S1 and the groove bottom-side cross-sectional area S2 of the circumferential groove 20 calculated as described above are configured such that the ratio S2/S1 of the groove bottom-side cross-sectional area S2 to the road contact surface-side cross-sectional area S1 of the circumferential groove 20 disposed at a position closest to the tire equatorial plane CL among the plurality of circumferential grooves 20 disposed in the tread portion 2 is the smallest. Therefore, in the present embodiment, the ratio S2/S1 of the groove bottom-side cross-sectional area S2 to the road contact surface-side cross-sectional area S1 of the center main groove 21, which is the circumferential groove 20 disposed at the position closest to the tire equatorial plane CL among the plurality of circumferential grooves 20, is the smallest.

In the present embodiment, when the ratios S2/S1 of the groove bottom-side cross-sectional area S2 to the road contact surface-side cross-sectional area S1 of the center main groove 21, the middle main groove 22, and the shoulder main groove 23 are compared, the value of S2/S1 decreases from the outer side in the tire width direction toward the inner side in the tire width direction. That is, the ratio S2/S1 of the groove bottom-side cross-sectional area S2 to the road contact surface-side cross-sectional area S1 of each of the center main groove 21, the middle main groove 22, and the shoulder main groove 23 satisfies the relationship S2/S1 of the center main groove 21≤S2/S1 of the middle main groove 22≤S2/S1 of the shoulder main groove 23.

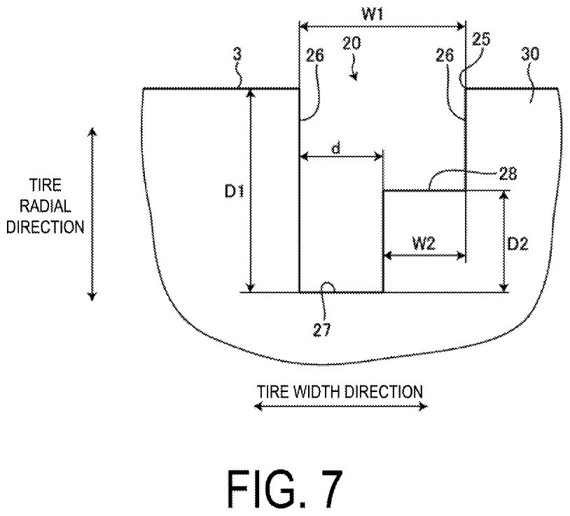

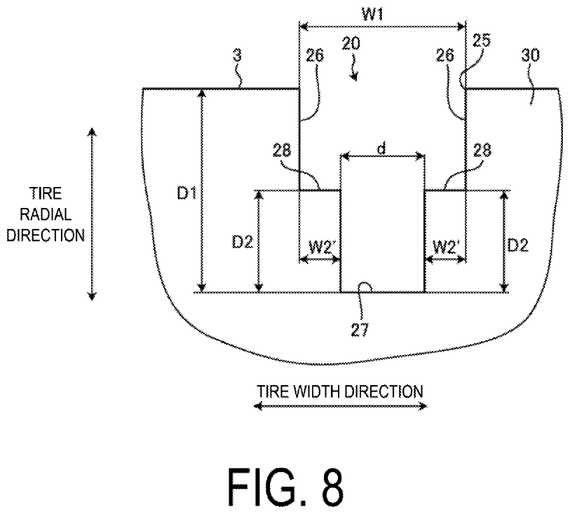

FIG. 7 is an explanatory diagram of dimensions of the projection portion 28 of the circumferential groove 20 illustrated in FIG. 4. FIG. 8 is an explanatory diagram of dimensions of the projection portion 28 of the circumferential groove 20 illustrated in FIG. 5. In the circumferential groove 20 having the projection portion 28, a width W2 of the projection portion 28 in the groove width direction of the circumferential groove 20 and a groove width W1 of the circumferential groove 20 satisfy a relationship 0.4≤W2/W1≤0.8. In this case, the groove width W1 of the circumferential groove 20 is a groove width at a position where the projection portion 28 is not disposed in the circumferential grooves 20, and specifically, is a groove width at a position of an opening portion 25 of the circumferential groove 20 with respect to the tread contact surface 3. The width W2 of the projection portion 28 in the groove width direction of the circumferential groove 20 is a projection amount of the projection portion 28 in the groove width direction from the groove wall 26 on which the projection portion 28 is disposed.

As shown in FIG. 8, in the case where the projection portion 28 is disposed to project from the groove walls 26 on both sides in the groove width direction of the circumferential groove 20, the width W2 of the projection portion 28 in the groove width direction of the circumferential groove 20 is a value obtained by summing widths W2′ of the projection portions 28 at the same position in the extension direction of the circumferential groove 20. That is, in the case where the projection portion 28 is disposed to project from the groove walls 26 on both sides in the groove width direction of the circumferential groove 20, the width W2 of the projection portion 28 in the groove width direction is a value obtained by adding a width W2′ of the projection portion 28 projecting from one groove wall 26 of the circumferential groove 20 and a width W2′ of the projection portion 28 projecting from the other groove wall 26.

In the circumferential groove 20 having the projection portion 28, the width W2 of the projection portion 28 in the groove width direction measured as described above and the groove width W1 of the circumferential groove 20 satisfy a relationship 0.4≤W2/W1≤0.8. Note that the relationship between the width W2 of the projection portion 28 and the groove width W1 of the circumferential groove 20 is preferably within the range 0.5≤W2/W1≤0.7.

In the circumferential groove 20 having the projection portion 28, a depth D2 of the projection portion 28 in the groove depth direction of the circumferential groove 20 and a groove depth D1 of the circumferential groove 20 satisfy a relationship 0.2≤D2/D1≤0.6. In this case, the depth D2 of the projection portion 28 in the groove depth direction of the circumferential groove 20 is a depth in the groove depth direction from the position of the end portion of the projection portion 28 on the outer side in the tire radial direction to the groove bottom 27 of the circumferential groove 20, that is, a depth in the tire radial direction. In other words, the depth D2 of the projection portion 28 in the groove depth direction of the circumferential groove 20 is a height of the projection portion 28 in the tire radial direction from the groove bottom 27 of the circumferential groove 20.

As shown in FIG. 8, in the case where the projection portion 28 is disposed to project from the groove walls 26 on both sides in the groove width direction of the circumferential groove 20, the depth D2 of both projection portions 28 projecting from the groove walls 26 on both sides in the groove width direction of the circumferential groove 20 is within the range 0.2≤D2/D1≤0.6 with respect to the groove depth D1 of the circumferential groove 20. Note that the relationship between the depth D2 of the projection portion 28 in the groove depth direction of the circumferential groove 20 and the groove depth D1 of the circumferential groove 20 is preferably within the range 0.3≤D2/D1≤0.5.

In the circumferential groove 20 having the projection portion 28, a distance d between the projection portion 28 and the groove wall 26 facing the projection portion 28 or a distance d between the projection portions 28 is within the range 1.0 mm≤d≤6.0 mm. That is, as illustrated in FIG. 7, in the case where the projection portion 28 disposed in the circumferential groove 20 is disposed on one groove wall 26 of the groove walls 26 on both sides in the groove width direction of the circumferential groove 20, the distance d between the projection portion 28 and the groove wall 26 facing the projection portion 28 is within the range 1.0 mm≤d≤6.0 mm. As illustrated in FIG. 8, in the case where the projection portion 28 disposed in the circumferential groove 20 is disposed on the groove walls 26 on both sides in the groove width direction of the circumferential groove 20, the distance d between the projection portions 28 disposed on the groove walls 26 on both sides is within a range 1.0 mm≤d≤6.0 mm.

As described above, in the circumferential groove 20 having the projection portion 28, the distance d between the projection portion 28 disposed in the groove and the portion facing the projection portion 28 in the groove width direction is within the range 1.0 mm≤d≤6.0 mm. Note that the distance d between the projection portion 28 disposed on the groove wall 26 of the circumferential groove 20 and the portion of the circumferential groove 20 facing the projection portion 28 in the groove width direction is preferably within the range 2.0 mm≤d≤5.0 mm.

The tread portion 2 in which the circumferential groove 20 having the projection portion 28 is disposed has a deformation potential Tp within the range 0.06≤Tp≤0.20 where the deformation potential Tp of the tread portion 2 is defined as a ratio D0/W0 of a thickness D0 (see FIG. 3) from the tread contact surface 3 to the circumferential reinforcing layer 145 to a width W0 (see FIG. 3) of the circumferential reinforcing layer 145 in the tire width direction.

The thickness D0 from the tread contact surface 3 to the circumferential reinforcing layer 145 in this case is a thickness from the tread contact surface 3 to a surface on the outer side in the tire radial direction of the circumferential reinforcing layer 145 at a center position in the tire width direction. That is, the thickness D0 from the tread contact surface 3 to the circumferential reinforcing layer 145 is a length in the tire radial direction from the tread contact surface 3 to the surface on the outer side in the tire radial direction of the circumferential reinforcing layer 145 on the tire equatorial plane CL. In a case where the circumferential groove 20 is disposed on the tire equatorial plane CL, the thickness D0 from the tread contact surface 3 to the circumferential reinforcing layer 145 is defined as a length in the tire radial direction from an intersection point of a profile of the tread contact surface 3, which is obtained by extending the shape of the tread contact surface 3 to a portion where the circumferential groove 20 is disposed, and the tire equatorial plane CL, to the surface on the outer side in the tire radial direction of the circumferential reinforcing layer 145.

The deformation potential Tp of the tread portion 2 defined as described above is a numerical value representing the ease of deformation of the tread portion 2, and indicates that the deformation of the tread portion 2 with respect to the load is small as the numerical value of Tp decreases, and the deformation of the tread portion 2 with respect to the load is large as the numerical value of Tp increases. The deformation potential Tp of the tread portion 2 defined as described above is preferably within the range 0.08≤Tp≤0.12.

At least one circumferential groove 20 of the plurality of circumferential grooves 20 has a deformation potential Gp within the range 0.06≤Gp≤0.35 where the deformation potential Gp of the circumferential groove 20 is obtained by multiplying the deformation potential Tp of the tread portion 2 by an aspect ratio D1/W1 of the circumferential groove 20, which is a ratio of the groove width W1 and the groove depth D1 of the circumferential groove 20, and dividing the resulting product by a position correction coefficient A of the circumferential groove 20. That is, the deformation potential Gp of the circumferential groove 20 is a value calculated for each circumferential groove 20 by the following Formula (2) or Formula (3).

$$Gp = Tp \times ( D 1 / W 1 ) / A \qquad ( 2 )$$

$$Gp = ( D 0 / W 0 ) \times ( D 1 / W 1 ) \times ( 1 / A ) \qquad ( 3 )$$

The position correction coefficient A of the circumferential groove 20 in this case is a coefficient calculated for each circumferential groove 20 for which the deformation potential Gp of the circumferential groove 20 is to be obtained. The position correction coefficient A of the circumferential groove 20 is derived from the following Formula (1) using a distance Wd in the tire width direction from the tire equatorial plane CL to a center of a groove width GC of the circumferential groove 20 for which the position correction coefficient A is to be obtained, and a width W0 in the tire width direction of the circumferential reinforcing layer 145. The center of the groove width GC of the circumferential groove 20 referred to herein is a center position in the groove width direction at the position of the opening portion 25 with respect to the tread contact surface 3 in the circumferential groove 20.

$$A = \{ Wd / ( W 0 / 2 ) \} + 1 \qquad ( 1 )$$

The deformation potential Gp of the circumferential groove 20 calculated as described above is a numerical value representing the ease of deformation of the circumferential groove 20 for each circumferential groove 20, and indicates that the deformation of the circumferential groove 20 under load is small as the numerical value of Gp decreases, and the deformation of the circumferential groove 20 under load is large as the numerical value of Tp increases.

The deformation potential Gp of the circumferential groove 20 is preferably such that the deformation potential Gp of the circumferential groove 20 disposed at least at a position in the tire width direction closest to the tire equatorial plane CL is within the range 0.06≤Gp≤0.35. The deformation potential Gp of the circumferential groove 20 is preferably within the range 0.08≤Gp≤0.25.

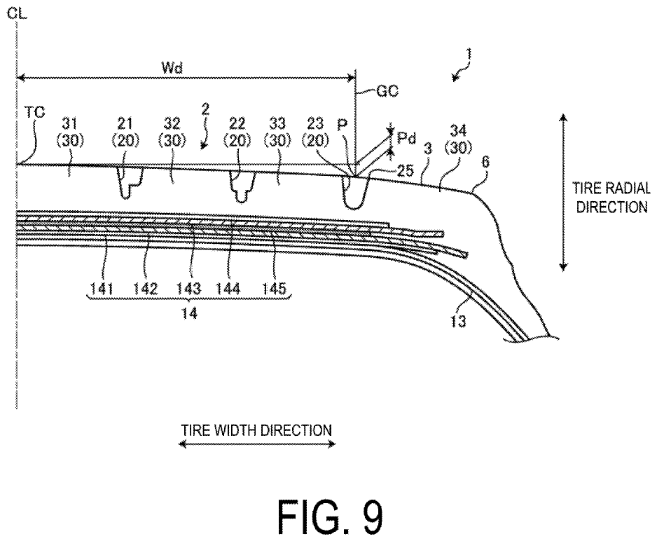

FIG. 9 is an explanatory diagram of a profile drop amount of the tread contact surface 3. The tread portion 2 is formed in a shape in which a profile of the tread contact surface 3 is curved in a direction of being convex outward in the tire radial direction in the tire meridian cross-section. That is, the profile of the tread contact surface 3 is formed in a shape curved in the tire meridian cross-section toward the inner side in the tire radial direction as it goes from the inner side toward the outer side in the tire width direction, but in the present embodiment, the degree of change in the profile of the tread contact surface 3 in the tire radial direction is reduced.

Therefore, the shoulder main groove 23, which is the circumferential groove 20 located on the outermost side in the tire width direction in the range in which the circumferential reinforcing layer 145 is disposed in the tire width direction among the plurality of circumferential grooves 20, is located at a position within a predetermined range in the tire radial direction. Specifically, in the shoulder main groove 23, a ratio Pd/Wd of a distance Pd in the tire radial direction between a position TC at which the tire equatorial plane CL intersects the tread contact surface 3 and an opening portion center P of the shoulder main groove 23 to a distance Wd in the tire width direction from the tire equatorial plane CL to a position of the center of the groove width GC of the shoulder main groove 23 is 0.04 or less.

The opening portion center P of the shoulder main groove 23 in this case is at a position of the center in the groove width direction of the opening portion 25 of the shoulder main groove 23 on the profile of the tread contact surface 3. The center of the groove width GC of the shoulder main groove 23 is at a position in the tire width direction of the opening portion center P of the shoulder main groove 23.

When mounting the pneumatic tire 1 according to the present embodiment to a vehicle, the pneumatic tire 1 is mounted on a rim wheel and inflated with air inside to an inflated state, and then mounted to the vehicle. When the vehicle on which the pneumatic tires 1 are mounted travels, the pneumatic tire 1 rotates while a lower portion of the tread contact surface 3 of the tread portion 2 is in contact with a road surface. When the vehicle on which the pneumatic tires 1 are mounted travels on a dry road surface, the vehicle travels mainly by transmitting a driving force and a braking force to the road surface and generating a turning force by friction forces between the tread contact surfaces 3 and the road surface.

In traveling on a wet road surface, water between the tread contact surface 3 and the road surface enters grooves such as the circumferential grooves 20, and the vehicle travels while the water between the tread contact surface 3 and the road surface is drained by the grooves. As a result, the tread contact surface 3 easily contacts the road surface, and the vehicle can travel by the friction force between the tread contact surface 3 and the road surface.

When the vehicle on which the pneumatic tires 1 are mounted travels, the pneumatic tire 1 rotates about the tire rotation axis, and thus a force toward the outer side in the tire radial direction acts on the tread portion 2 due to a centrifugal force caused by the rotation of the pneumatic tire 1. Here, both ends of the tread portion 2 in the tire width direction are connected to the sidewall portions 8, and regions at or near both ends of the tread portion 2 in the tire width direction are regulated from moving toward the outer side in the tire radial direction by the sidewall portions 8. Therefore, the tread portion 2 on which the centrifugal force acts due to the rotation of the pneumatic tire 1 is likely to be bent in a shape in which the central region in the tire width direction is convex toward the outer side in the tire radial direction.

In this manner, when the tread portion 2 is bent in a direction in which the outer diameter of the tread portion 2 in the central region in the tire width direction increases due to the rotation of the pneumatic tire 1, the belt layer 14 disposed in the tread portion 2 is also bent and deformed. When the belt layer 14 is deformed, distortion occurs between the rubber member around the belt layer 14 and the belt layer 14, cracks or the like occur in the rubber member around the belt layer 14, and there is a risk that belt durability, which is durability around the belt layer 14 including the belt layer 14, is likely to decrease.

In contrast, in the pneumatic tire 1 according to the present embodiment, the belt layer 14 includes the circumferential reinforcing layer 145 in which the inclination angle of the belt cords is 5° or less. Therefore, the circumferential reinforcing layer 145 can suppress the extension of the belt layer 14 in the tire circumferential direction, and when a centrifugal force about the tire rotation axis acts on the belt layer 14, the belt layer 14 can be suppressed from being enlarged in the tire radial direction when the centrifugal force acts on the belt layer 14. This makes it possible to suppress deformation of the tread portion 2 in a direction in which the outer diameter of the tread portion 2 in the central region in the tire width direction increases during rotation of the pneumatic tire 1, thereby suppressing distortion between the belt layer 14 and the rubber member around the belt layer 14. Therefore, the occurrence of cracks or the like around the belt layer 14 can be suppressed, and the belt durability can be ensured.

On the other hand, when the circumferential reinforcing layer 145 is disposed in the belt layer 14, the tread portion 2 is less likely to be deformed upon contact of the tread contact surface 3 with the ground due to the increased rigidity of the tread portion 2, and thus the ground contact length is likely to be shortened. In particular, the shoulder regions, which are regions at or near both ends in the tire width direction, are less likely to contact the ground due to the increased rigidity of the tread portion 2, and therefore the ground contact length of the shoulder regions is particularly likely to be shortened. When the ground contact length of the shoulder region is shortened, the load distribution of the center region in the tire width direction increases upon contact of the tread contact surface 3 with the ground, and therefore the ground contact pressure of the center region is likely to increase.

When the ground contact pressure of the center region increases upon contact of the tread contact surface 3 with the ground, the deformation of the circumferential groove 20 disposed in the center region is likely to increase due to the increased ground contact pressure. There is a case where a stone falls on a road surface on which a vehicle travels, and such a stone on the road surface may enter the circumferential groove 20 of the tread contact surface 3 during traveling of the vehicle. In a case where a stone on a road surface enters the circumferential groove 20 and the stone is bitten into the circumferential groove 20 in a state where the ground contact pressure of the center region is high and the deformation of the circumferential groove 20 is likely to increase, the stone is likely to be strongly pushed toward the groove bottom 27 side of the circumferential groove 20 by the high ground contact pressure. When the stone is pushed into the groove bottom 27 side of the circumferential groove 20 in this manner, there is a risk that so-called stone drilling, in which the groove bottom 27 of the circumferential groove 20 is damaged due to the pushed-in stone bitten into the groove bottom 27, is likely to occur.

In contrast, in the pneumatic tire 1 according to the present embodiment, the projection portion 28 projecting into the groove from the groove wall 26 on at least one side and connected to the groove bottom 27 is disposed in at least one circumferential groove 20 among the circumferential grooves 20 disposed in the range in which the circumferential reinforcing layer 145 is disposed in the tire width direction. Accordingly, the projection portion 28 can be disposed in the circumferential groove 20 disposed at a position close to the center region where the ground contact pressure is likely to increase when the tread contact surface 3 comes into contact with the ground, and even when a stone is bitten into the circumferential groove 20 at a position close to the center region, the stone can be suppressed from reaching the groove bottom 27. Accordingly, the occurrence of stone drilling can be suppressed and the stone drilling resistance can be ensured.

In the circumferential groove 20 having the projection portion 28, the road contact surface-side cross-sectional area S1, which is the cross-sectional area of the circumferential groove 20 on the tread contact surface 3 side, and the groove bottom-side cross-sectional area S2, which is the cross-sectional area of the circumferential groove 20 on the groove bottom 27 side, satisfy the relationship 0.1≤S2/S1≤0.7, and thus movement of the stone bitten in the circumferential groove 20 toward the groove bottom 27 side can be suppressed by the projection portion 28 while suppressing an excessive increase in an amount of the rubber member at or near the belt layer 14. That is, if the relationship between the road contact surface-side cross-sectional area S1 and the groove bottom-side cross-sectional area S2 of the circumferential groove 20 is S2/S1<0.1, the groove bottom-side cross-sectional area S2 is small, and thus there is a risk that the amount of the rubber member at or near the groove bottom 27 of the circumferential groove 20, that is, at or near the belt layer 14 may excessively increase. In this case, since the amount of the rubber member at or near the belt layer 14 is large, an amount of heat generated at or near the belt layer 14 during rotation of the pneumatic tire 1 increases, and, improvement of belt durability may become difficult due to a resulting temperature rise. If the relationship between the road contact surface-side cross-sectional area S1 and the groove bottom-side cross-sectional area S2 of the circumferential groove 20 is S2/S1>0.7, the groove bottom-side cross-sectional area S2 is large, and thus there is a risk that it may be difficult to suppress the movement of the stone toward the groove bottom 27 side by the projection portion 28 when the stone is bitten in the circumferential groove 20.

In contrast, when the relationship between the road contact surface-side cross-sectional area S1 and the groove bottom-side cross-sectional area S2 of the circumferential groove 20 is within the range 0.1≤S2/S1≤0.7, the movement of the stone bitten in the circumferential groove 20 toward the groove bottom 27 side can be suppressed by the projection portion 28 while suppressing an excessive increase in the amount of the rubber member at or near the belt layer 14. Therefore, the belt durability can be improved by suppressing the amount of the rubber member at or near the belt layer 14, and the stone drilling resistance can be ensured by suppressing the movement of the stone bitten in the circumferential groove 20 toward the groove bottom 27 side by the projection portion 28.

The tread portion 2 has the deformation potential Tp within the range 0.06≤Tp≤0.20 where the deformation potential Tp of the tread portion 2 is the ratio D0/W0 of the width W0 of the circumferential reinforcing layer 145 in the tire width direction and the thickness D0 from the tread contact surface 3 to the circumferential reinforcing layer 145, and thus the ease of deformation of the circumferential groove 20 can be made appropriate. That is, if the deformation potential Tp of the tread portion 2 is Tp<0.06, the deformation potential Tp of the tread portion 2 is too small, and thus the thickness D0 from the tread contact surface 3 to the circumferential reinforcing layer 145 becomes too small, and there is a risk that a portion of the tread portion 2 on the outer side in the tire radial direction with respect to the circumferential reinforcing layer 145 is unlikely to deform. In this case, since the deformation of the circumferential groove 20 under load becomes too small, when a stone on a road surface is bitten into the circumferential groove 20, the stone is continuously sandwiched between the groove walls 26 of the circumferential groove 20, and the stone is not discharged, so that there is a risk that it may become difficult to suppress damage to the groove bottom 27 due to the stone.

If the deformation potential Tp of the tread portion 2 is Tp>0.20, the deformation potential Tp of the tread portion 2 is too large, and thus the thickness D0 from the tread contact surface 3 to the circumferential reinforcing layer 145 becomes too large, and there is a risk that a portion of the tread portion 2 on the outer side in the tire radial direction with respect to the circumferential reinforcing layer 145 is likely to deform. In this case, since the deformation of the circumferential groove 20 under load becomes too large, when a stone on the road surface is bitten into the circumferential groove 20, the stone easily reaches the groove bottom 27 of the circumferential groove 20, and there is a risk that it may become difficult to suppress damage to the groove bottom 27 due to the stone.

In contrast, when the deformation potential Tp of the tread portion 2 is within the range 0.06≤Tp≤0.20, the ease of deformation of the portion of the tread portion 2 on the outer side in the tire radial direction with respect to the circumferential reinforcing layer 145 can be made appropriate, and the ease of deformation of the circumferential groove 20 under load can be made appropriate. Accordingly, even when a stone on a road surface is bitten into the circumferential groove 20, the stone can be discharged early by appropriate deformation of the circumferential groove 20, and the stone bitten in the circumferential groove 20 can be suppressed from reaching the groove bottom 27, and therefore the stone drilling resistance can be ensured. As a result, the belt durability can be improved while providing ensured stone drilling resistance.

At least one circumferential groove 20 of the plurality of circumferential grooves 20 disposed in the tread portion 2 has the deformation potential Gp within the range 0.06≤Gp≤0.35 where the deformation potential Gp of the circumferential groove 20 is obtained by multiplying the deformation potential Tp of the tread portion 2 by the aspect ratio D1/W1 of the circumferential groove 20 and dividing the resulting product by the position correction coefficient A of the circumferential groove 20, and therefore the stone drilling resistance can be improved. That is, if the deformation potential Gp of the circumferential groove 20 is Gp<0.06, the deformation potential Gp of the circumferential groove 20 is too small, and thus the deformation potential Tp of the tread portion 2 is small, the shape of the circumferential groove 20 is a shape that is not easily deformed, or the circumferential groove 20 is disposed at a position close to the outer side in the tire width direction, and therefore there is a risk that the deformation of the circumferential groove 20 under load may become too small. In this case, when a stone on the road surface is bitten into the circumferential groove 20, the stone is continuously sandwiched between the groove walls 26 of the circumferential groove 20 due to the small deformation of the circumferential groove 20, and the stone is not discharged, so that there is a risk that it may become difficult to suppress damage to the groove bottom 27 due to the stone.

If the deformation potential Gp of the circumferential groove 20 is Gp>0.35, the deformation potential Gp of the circumferential groove 20 is too large, and thus the deformation potential Tp of the tread portion 2 is large, the shape of the circumferential groove 20 is a shape that is easily deformed, or the circumferential groove 20 is disposed at a position close to the center in the tire width direction, and therefore there is a risk that the deformation of the circumferential groove 20 under load may become too large. In this case, when a stone on the road surface is bitten into the circumferential groove 20, the stone easily reaches the groove bottom 27 of the circumferential groove 20 due to the large deformation of the circumferential groove 20, and there is a risk that it may be difficult to suppress damage to the groove bottom 27 due to the stone.

In contrast, when the deformation potential Gp of the circumferential groove 20 is within the range 0.06≤Gp≤0.35, the ease of deformation of the circumferential groove 20 under load can be made appropriate. Accordingly, even when a stone on a road surface is bitten into the circumferential groove 20, the stone can be discharged early by appropriate deformation of the circumferential groove 20, and the stone bitten in the circumferential groove 20 can be suppressed from reaching the groove bottom 27. As a result, the stone drilling resistance can be improved.

The circumferential groove 20 disposed at the position closest to the tire equatorial plane CL among the plurality of circumferential grooves 20 has the smallest ratio S2/S1 of the road contact surface-side cross-sectional area S1 and the groove bottom-side cross-sectional area S2, and thus the stone drilling resistance can be more reliably improved. That is, at or near the tire equatorial plane CL, the ground contact pressure upon the contact of the tread contact surface 3 with the ground is likely to be higher than that in a portion close to the shoulder portion 6, thus the stone on the road surface bitten in the circumferential groove 20 is pushed toward the groove bottom 27 side by the high ground contact pressure, and the groove bottom 27 is likely to be damaged. Therefore, by forming the circumferential groove 20 disposed at a position closest to the tire equatorial plane CL such that the ratio S2/S1 of the groove bottom-side cross-sectional area S2 to the road contact surface-side cross-sectional area S1 is the smallest, even when a stone is bitten into the circumferential groove 20 disposed at a position where the ground contact pressure is likely to be high, movement of the stone toward the groove bottom 27 side due to the high ground contact pressure can be easily suppressed. As a result, the stone drilling resistance can be more reliably improved.

By making the ratio S2/S1 of the groove bottom-side cross-sectional area S2 to the road contact surface-side cross-sectional area S1 of the circumferential groove 20 disposed at the position closest to the tire equatorial plane CL among the plurality of circumferential grooves 20 the smallest, the ratio S2/S1 of the road contact surface-side cross-sectional area S1 and the groove bottom-side cross-sectional area S2 of the circumferential groove 20 disposed at a position away from the tire equatorial plane CL can be made relatively large. By increasing the ratio S2/S1 of the groove bottom-side cross-sectional area S2 to the road contact surface-side cross-sectional area S1 of the circumferential groove 20 disposed at the position away from the tire equatorial plane CL in this manner, a groove cross-sectional area obtained by adding the road contact surface-side cross-sectional area S1 and the groove bottom-side cross-sectional area S2 of the circumferential groove 20 disposed at the position away from the tire equatorial plane CL can be increased. This makes it possible to ensure drainage properties during travel on a wet road surface by the circumferential groove 20 disposed at the position away from the tire equatorial plane CL. As a result, the stone drilling resistance can be improved while providing ensured the drainage properties.

In the circumferential groove 20 having the projection portion 28, the width W2 of the projection portion 28 in the groove width direction of the circumferential groove 20 and the groove width W1 of the circumferential groove 20 satisfy the relationship 0.4≤W2/W1≤0.8, and thus the belt durability can be improved while more reliably providing ensured stone drilling resistance. That is, if the relationship of the width W2 of the projection portion 28 of the circumferential groove 20 and the groove width W1 of the circumferential groove 20 is W2/W1<0.4, the width W2 of the projection portion 28 with respect to the groove width W1 of the circumferential groove 20 is too small, and thus there is a risk that it may be difficult to suppress the movement of a stone toward the groove bottom 27 side by the projection portion 28 when the stone is bitten in the circumferential groove 20. If the relationship of the width W2 of the projection portion 28 of the circumferential groove 20 and the groove width W1 of the circumferential groove 20 is W2/W1>0.8, the width W2 of the projection portion 28 with respect to the groove width W1 of the circumferential groove 20 is too large, and therefore, there is a risk that the amount of the rubber member at or near the belt layer 14 may excessively increase due to the increased volume of the projection portion 28. In this case, since the amount of the rubber member at or near the belt layer 14 is large, an amount of heat generated at or near the belt layer 14 during rotation of the pneumatic tire 1 increases, and, improvement of belt durability may become difficult due to a resulting temperature rise.

In contrast, when the relationship of the width W2 of the projection portion 28 of the circumferential groove 20 and the groove width W1 of the circumferential groove 20 is within the range 0.4≤W2/W1≤0.8, the movement of the stone bitten in the circumferential groove 20 toward the groove bottom 27 side can be more reliably suppressed by the projection portion 28 while suppressing the excessive increase in the amount of the rubber member at or near the belt layer 14. As a result, the belt durability can be improved while more reliably providing ensured stone drilling resistance.

Since the depth D2 of the projection portion 28 and the groove depth D1 of the circumferential groove 20 in the groove depth direction of the circumferential groove 20 satisfy the relationship 0.2≤D2/D1≤0.6, the belt endurance can be improved while more reliably providing ensured stone drilling resistance. That is, if the relationship of the depth D2 of the projection portion 28 and the groove depth D1 of the circumferential groove 20 in the groove depth direction of the circumferential groove 20 is D2/D1<0.2, the depth D2 of the projection portion 28 with respect to the groove depth D1 of the circumferential groove 20 is too shallow, and thus there is a risk that it may be difficult to suppress the movement of the stone toward the groove bottom 27 side by the projection portion 28 when the stone is bitten in the circumferential groove 20. If the relationship of the depth D2 of the projection portion 28 and the groove depth D1 of the circumferential groove 20 in the groove depth direction of the circumferential groove 20 is D2/D1>0.6, the depth D2 of the projection portion 28 with respect to the groove depth D1 of the circumferential groove 20 is too deep, and thus the amount of the rubber member at or near the belt layer 14 may excessively increase due to the increased volume of the projection portion 28. In this case, since the amount of the rubber member at or near the belt layer 14 is large, an amount of heat generated at or near the belt layer 14 during rotation of the pneumatic tire 1 increases, and, improvement of belt durability may become difficult due to a resulting temperature rise.

In contrast, when the relationship of the depth D2 of the projection portion 28 and the groove depth D1 of the circumferential groove 20 in the direction of the groove depth of the circumferential groove 20 is within the range 0.2≤D2/D1≤0.6, the movement of the stone bitten in the circumferential groove 20 toward the groove bottom 27 side can be more reliably suppressed by the projection portion 28 while suppressing the excessive increase in the amount of the rubber member at or near the belt layer 14. As a result, the belt durability can be improved while more reliably providing ensured stone drilling resistance.

Since the distance d between the projection portion 28 disposed in the circumferential groove 20 and the portion of the circumferential groove 20 facing the projection portion 28 in the groove width direction is within the range 1.0 mm≤d≤6.0 mm, the belt durability can be improved while more reliably providing ensured stone drilling resistance. That is, if the distance d between the projection portion 28 and the portion of the circumferential groove 20 facing the projection portion 28 in the groove width direction is less than 1.0 mm, the distance d between the projection portion 28 and the portion facing the projection portion 28 is too small, and thus there is a risk that the volume of the projection portion 28 may excessively increase. In this case, since the amount of the rubber member at or near the belt layer 14 is large, an amount of heat generated at or near the belt layer 14 during rotation of the pneumatic tire 1 increases, and due to a resulting temperature rise, there is a risk that improvement of belt durability may become difficult. If the distance d between the projection portion 28 and the portion of the circumferential groove 20 facing the projection portion 28 in the groove width direction is greater than 6.0 mm, the distance d between the projection portion 28 and the portion facing the projection portion 28 is too large, and thus there is a risk that it may be difficult to suppress the movement of the stone toward the groove bottom 27 side by the projection portion 28 when the stone is bitten in the circumferential groove 20.

In contrast, when the distance d between the projection portion 28 and the portion of the circumferential groove 20 facing the projection portion 28 in the groove width direction is within the range 1.0 mm≤d≤6.0 mm, the movement of the stone bitten in the circumferential groove 20 toward the groove bottom 27 side can be more reliably suppressed by the projection portion 28 while suppressing the excessive increase in the amount of the rubber member at or near the belt layer 14. As a result, the belt durability can be improved while more reliably providing ensured stone drilling resistance.

Since the circumferential reinforcing layer 145 is disposed between the pair of cross belt layers 142 and 143 and is formed with the width in the tire width direction narrower than the widths of the cross-belt layers 142 and 143, the end portion of the inner cross belt layer 142 in the tire width direction and the end portion of the outer cross belt layer 143 in the tire width direction can be separated in the tire radial direction. Accordingly, the rubber member can be inserted into a portion between the end portion region of the inner cross belt layer 142 in the tire width direction and the end portion region of the outer cross belt layer 143 in the tire width direction, and thus cracks of the rubber member caused by deformation of the belt layer 14 can be suppressed.

That is, by increasing the number of elastically deformable rubber members by inserting the rubber members between the end portion regions of the pair of cross belt layers 142 and 143 in the tire width direction, it is possible to reduce the distortion of the rubber members when the belt layer 14 and the rubber members in the vicinity thereof are deformed by the load during traveling of the vehicle. This makes it possible to suppress the occurrence of cracks in the rubber members around the belt layer 14 due to distortion of the rubber members disposed in the end portion regions in the tire width direction of the pair of cross belt layers 142 and 143. As a result, the belt durability can be improved.

In the shoulder main groove 23, which is the circumferential groove 20 located on the outermost side in the tire width direction in the range in which the circumferential reinforcing layer 145 is disposed in the tire width direction, the ratio Pd/Wd of a distance Pd in the tire radial direction between the position TC at which the tire equatorial plane CL intersects the tread contact surface 3 and the opening portion center P of the shoulder main groove 23 to a distance Wd in the tire width direction from the tire equatorial plane CL to the position of the center of the groove width GC of the shoulder main groove 23 is 0.04 or less, and thus the stone drilling resistance can be more reliably improved. That is, if the ratio Pd/Wd of the distance Pd to the distance Wd is greater than 0.04, there is a risk that the distance Pd relative to the distance Wd may be too large, that is, the position of the opening portion center P of the shoulder main groove 23 may be excessively located on the inner side in the tire radial direction with respect to the position TC where the tread contact surface 3 and the tire equatorial plane CL intersect. In this case, the shoulder region is less likely to come into contact with the ground when the tread contact surface 3 comes into contact with the ground, and the ground contact length of the shoulder region is shortened, and thus the ground contact pressure of the center region is likely to increase. Accordingly, in a region at or near the center region, the circumferential groove 20 disposed in the region at or near the center region is likely to be deformed due to the high ground contact pressure, and when a stone on a road surface is bitten into the circumferential groove 20, it may become difficult to suppress the stone from reaching the groove bottom 27 of the circumferential groove 20 and biting into the groove bottom 27.

In contrast, when the ratio Pd/Wd of the distance Pd to the distance Wd is 0.04 or less, the position of the opening portion center P of the shoulder main groove 23 can be suppressed from being excessively located on the inner side in the tire radial direction with respect to the position TC where the tread contact surface 3 and the tire equatorial plane CL intersect. Accordingly, the ground contact length of the shoulder region upon contact of the tread contact surface 3 with the ground can be ensured, and the ground contact pressure of the tread contact surface 3 can be dispersed over a wide range, so that the ground contact pressure of the center region can be suppressed from increasing. Therefore, it is possible to suppress the circumferential groove 20 disposed at or near the center region from being easily deformed due to the high ground contact pressure, and to suppress a stone from easily reaching the groove bottom 27 of the circumferential groove 20 when the stone on the road surface is bitten in the circumferential groove 20. As a result, the stone drilling resistance can be more reliably improved.

### Modified Examples

Note that, in the above-described embodiment, the projection portion 28 disposed in the circumferential groove 20 has been described as being disposed on one groove wall 26 of the groove walls 26 on both sides of the circumferential groove 20 as illustrated in FIG. 4 and as being disposed on the groove walls 26 on both sides as illustrated in FIG. 5, but the projection portion 28 may be disposed in other forms.

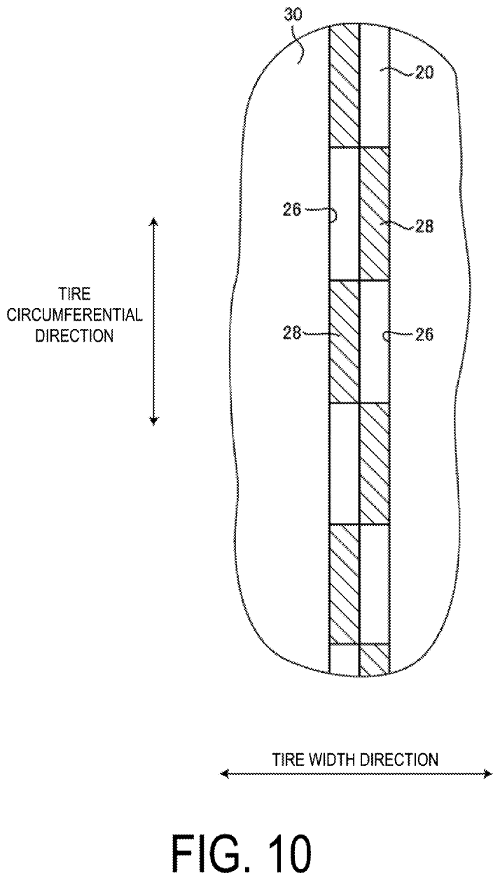

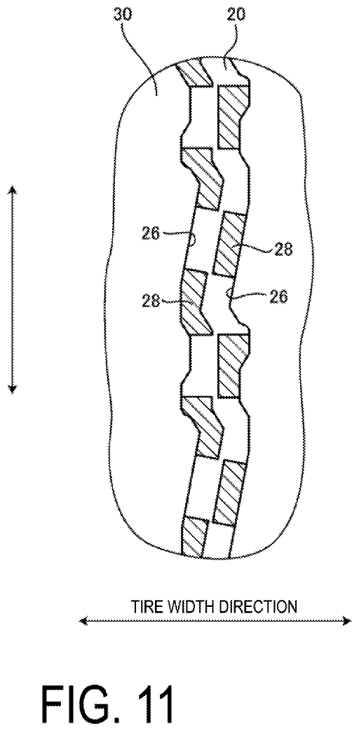

FIGS. 10 and 11 are explanatory diagram of aspects where the projection portions 28 are alternately disposed on the groove walls 26 on both sides of the circumferential groove 20, illustrating modified examples of the pneumatic tire 1 according to the embodiment. The projection portions 28 disposed in the circumferential groove 20 may be disposed only on one of the groove walls 26 facing each other at each position in the extension direction of the circumferential groove 20 having the projection portion 28, and may be alternately disposed in the extension direction of the circumferential groove 20 with respect to the facing groove walls 26. That is, the projection portions 28 disposed in the circumferential groove 20 may be disposed such that, of the groove walls 26 on both sides in the groove width direction of the projection portion 28, the groove walls 26 on which the projection portions 28 are disposed may be alternately and repeatedly disposed on the groove wall 26 on one side and the groove wall 26 on the other side in the extension direction of the circumferential groove 20. In this case, the circumferential groove 20 in which the projection portions 28 are disposed may be formed to extend linearly in the tire circumferential direction as illustrated in FIG. 10, or may be formed in a zigzag shape that repeatedly oscillates in the tire width direction while extending in the tire circumferential direction as illustrated in FIG. 11.

The projection portions 28 disposed in the circumferential groove 20 are alternately disposed on the groove walls 26 on both sides in the groove width direction of the projection portions 28 as described above, so that, when a stone on a road surface bitten in the circumferential groove 20 moves in the extension direction of the circumferential groove 20 in the circumferential groove 20 with the rotation of the pneumatic tire 1, the projection portions 28 on both sides in the groove width direction can alternately abut against the stone. Accordingly, it is possible to easily discharge the stone bitten in the circumferential groove 20 to the outside of the circumferential groove 20, and to suppress the stone from easily reaching the groove bottom 27 of the circumferential groove 20. As a result, the stone drilling resistance can be more reliably improved.

Note that in the above-described embodiment, the number of circumferential grooves 20 disposed in the tread portion 2 is six, but the number of circumferential grooves 20 may be other than six. In the embodiment described above, although the pneumatic tire 1 is used for description as an example of the tire according to the embodiment of the present invention, the tire according to the embodiment of the present invention may be a tire other than the pneumatic tire 1. The tire according to the embodiment of the present invention may be, for example, a so-called airless tire that can be used without filling a gas.

### EXAMPLES

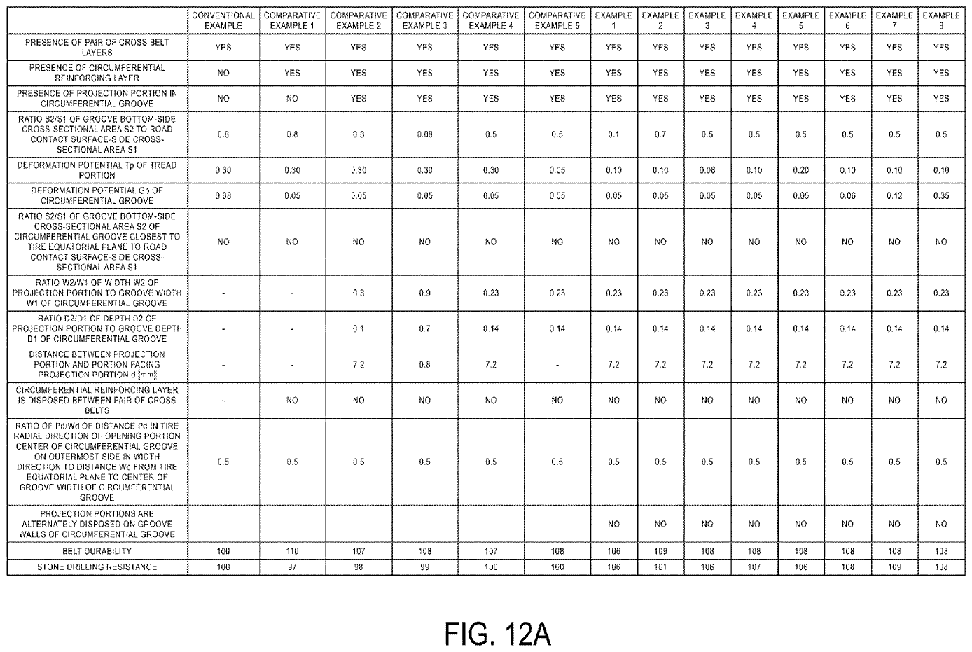

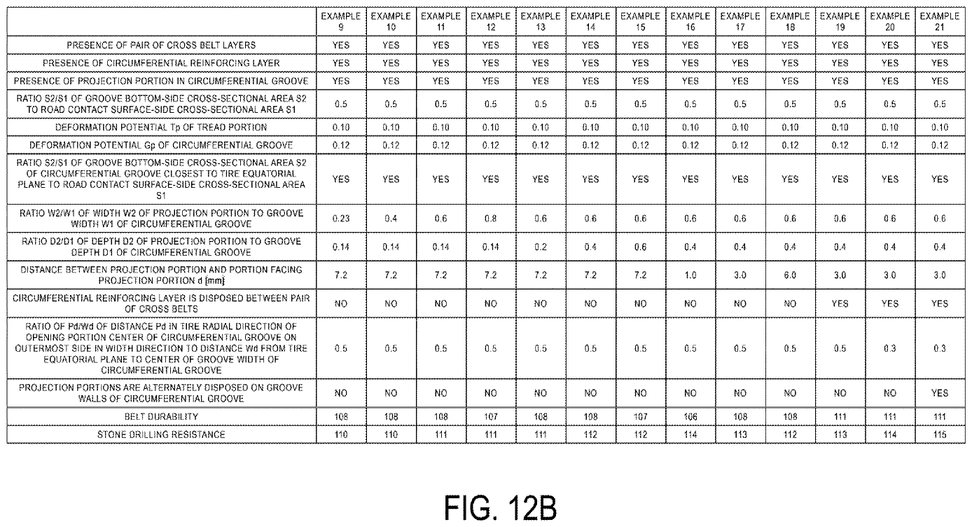

FIGS. 12A and 12B are tables showing results of performance evaluation tests of pneumatic tires. In relation to the pneumatic tire 1 described above, description will be given of performance evaluation tests conducted on a pneumatic tire according to Conventional Example, the pneumatic tires 1 according to embodiments of the present invention, and pneumatic tires according to Comparative Examples to be compared with pneumatic tires 1 according to the embodiments of the present invention. For performance evaluation tests, tests on belt durability and stone drilling resistance were performed.

The performance evaluation tests were conducted by mounting the pneumatic tires 1, having a nominal size of 445/50R22.5 as specified by TRA, on rim wheels of regular rims specified by TRA, and adjusting the air pressure to the maximum air pressure specified by TRA.

The evaluation method of each test item was as follows: for the belt durability, a travel test was performed by an indoor drum testing machine with a load set to 120% of a specified load and a speed set to 60 km/h, a travel distance until a failure occurred around the belt layer was measured, and the measured travel distance was expressed as an index with the value of the Conventional Example described later as 100. The belt durability indicates that the larger this value, the less likely a failure occurs around the belt layer, and the belt durability is improved.

The stone drilling resistance was evaluated by running a test vehicle equipped with the test tires on a rough road for 40 km, measuring the number of damaged groove bottoms caused by stones bitten into the circumferential grooves, and expressing the reciprocal of the measured number of damaged groove bottoms as an index with the Conventional Example described below as 100. The stone drilling resistance indicates that the larger this value, the less damage to the groove bottom is caused by stones bitten into the circumferential grooves, and the stone drilling resistance is improved.

The performance evaluation tests were performed on twenty-seven types of pneumatic tires that are a pneumatic tire of Conventional Example as an example of a conventional pneumatic tire, pneumatic tires of Examples 1 to 21 corresponding to the pneumatic tire 1 according to an embodiment of the present invention, and pneumatic tires of Comparative Examples 1 to 5 corresponding to pneumatic tires compared with the pneumatic tire 1 according to an embodiment of the present invention. Among these, in the pneumatic tire of the Conventional Example, a circumferential reinforcing layer is not provided, and a projection portion is not disposed in the circumferential groove. In Comparative Example 1, the circumferential reinforcing layer is provided, but the projection portion is not disposed in the circumferential groove. In Comparative Examples 2 and 3, the projection portion is disposed in the circumferential groove, but the road contact surface-side cross-sectional area S1 and the groove bottom-side cross-sectional area S2 do not satisfy the relationship 0.1≤S2/S1≤0.7. In Comparative Examples 4 and 5, the road contact surface-side cross-sectional area S1 and the groove bottom-side cross-sectional area S2 satisfy the relationship 0.1≤S2/S1≤0.7, but the deformation potential Tp of the tread portion is not within the range 0.06≤Tp≤0.20.

In contrast, in all of Examples 1 to 21, which are examples of the pneumatic tire 1 according to the embodiment of the present invention, the circumferential reinforcing layer 145 is provided, the projection portion 28 is disposed in the circumferential groove 20, the road contact surface-side cross-sectional area S1 and the groove bottom-side cross-sectional area S2 of the circumferential groove 20 satisfy the relationship 0.1≤S2/S1≤0.7, and the deformation potential Tp of the tread portion 2 is within the range 0.06≤Tp≤0.20.

Furthermore, the pneumatic tires 1 according to Examples 1 to 21 differ from each other in whether or not the deformation potential Gp of the circumferential groove 20 is within the range 0.06≤Gp≤0.35, and whether or not the ratio S2/S1 of the groove bottom-side cross-sectional area S2 to the road contact surface-side cross-sectional area S1 of the circumferential groove 20 disposed at the position closest to the tire equatorial plane CL is the smallest, in the ratio W2/W1 of the groove width W2 of the projection portion 28 to the groove width W1 of the circumferential groove 20 having the projection portion 28, the ratio D2/D1 of the depth D2 of the projection portion 28 to the groove depth D1 of the circumferential groove 20 having the projection portion 28, the distance d (mm) between the projection portion 28 and the portion facing the projection portion 28 in the circumferential groove 28, whether or not the circumferential reinforcing layer 145 is disposed between the pair of cross belt layers 142 and 143, the ratio Pd/Wd of the distance Wd from the tire equatorial plane CL to the position of the center of the groove width GC of the circumferential groove 20 to the distance Pd in the tire radial direction between the opening portion center P of the circumferential groove 20 located on the outermost side in the tire width direction in the range in which the circumferential reinforcing layer 145 is disposed in the tire width direction and the position TC at which the tread contact surface 3 and the tire equatorial plane CL intersect, and whether or not the projection portion 28 is alternately disposed on the groove wall 26 of the circumferential groove 20.

As a result of performing the evaluation tests by using the pneumatic tires 1, it was revealed as indicated in FIGS. 12A and 12B that compared with Conventional Example, the pneumatic tires 1 according to Examples 1 to 21 all can improve both the stone drilling resistance and the belt durability. That is, the pneumatic tires 1 according to Examples 1 to 21 can provide improved belt durability while providing ensured stone drilling resistance.

The present disclosure includes the following Aspects.

Aspect 1 includes a tire, comprising
a belt layer disposed in a tread portion and including a plurality of belt plies,
the belt layer including
   a pair of cross belt layers in which inclination directions of belt cords in a tire width direction with respect to a tire circumferential direction are opposite to each other; and,
   a circumferential reinforcing layer in which an inclination angle of the belt cords in the tire width direction with respect to the tire circumferential direction is 5° or less;
the tread portion includes at least one circumferential groove extending in the tire circumferential direction in a range in which the circumferential reinforcing layer is disposed in the tire width direction,
in at least one circumferential groove of the at least one circumferential groove, a projection portion projecting from a groove wall on at least one side into the circumferential groove and connected to a groove bottom is disposed;
in the circumferential groove including the projection portion, a road contact surface-side cross-sectional area S1, which is a cross-sectional area from a tread contact surface to a position corresponding to one-half of a groove depth of the circumferential groove, and a groove bottom-side cross-sectional area S2, which is a cross-sectional area from the position corresponding to one-half of the groove depth from the tread contact surface to the groove bottom, satisfying a relationship 0.1≤S2/S1≤0.7; and,
in the tread portion, a ratio D0/W0 of a thickness D0 from the tread contact surface to the circumferential reinforcing layer to a width W0 of the circumferential reinforcing layer in the tire width direction being defined as a deformation potential Tp of the tread portion, and the deformation potential Tp being within a range 0.06≤Tp≤0.20.

Aspect 2 includes the tire according to Aspect 1, wherein in the at least one circumferential groove of the at least one circumferential groove, a deformation potential Gp of the circumferential groove calculated by multiplying the deformation potential Tp of the tread portion by an aspect ratio D1/W1 of the circumferential groove, which is a ratio of a groove depth D1 to a groove width W1 of the circumferential groove and dividing the resulting product by a position correction coefficient A of the circumferential groove derived from Formula (1) using a distance Wd in the tire width direction from a tire equatorial plane to a center of a groove width of the circumferential groove and the width W0 in the tire width direction of the circumferential reinforcing layer is within a range 0.06≤Gp≤0.35.

$$A = \{ Wd / ( W 0 / 2 ) \} + 1 \qquad ( 1 )$$

Aspect 3 includes tire according to Aspects [1] or [2], wherein a plurality of the circumferential groove are disposed in the tread portion, and the circumferential grooves each have a smallest ratio S2/S1 of the groove bottom-side cross-sectional area S2 to the road contact surface-side cross-sectional area S1 of the circumferential groove disposed at a position closest to a tire equatorial plane among the plurality of circumferential grooves.

Aspect 4 includes the tire according to any one of Aspects [1] to [3], wherein in the circumferential groove including the projection portion, a width W2 of the projection portion in a groove width direction of the circumferential groove and a groove width W1 of the circumferential groove satisfy a relationship 0.4≤W2/W1≤0.8.

Aspect 5 includes the tire according to any one of Aspects [1] to [4], wherein in the circumferential groove including the projection portion, a depth D2 of the projection portion in a groove depth direction of the circumferential groove and a groove depth D1 of the circumferential groove satisfy a relationship 0.2≤D2/D1≤0.6.

Aspect 6 includes the tire according to any one of Aspects [1] to [5], wherein in the circumferential groove including the projection portion, a distance d between the projection portion and a portion of the circumferential groove facing the projection portion in a groove width direction is within a range 1.0 mm≤d≤6.0 mm.

Aspect 7 the tire according to any one of Aspects [1] to [6], wherein the circumferential reinforcing layer is disposed between the pair of cross belt layers, and is formed to have a width in the tire width direction narrower than a width of the cross-belt layers.

Aspect 8 includes the tire according to any one of Aspects [1] to [7], wherein
a plurality of the circumferential groove are disposed in the tread portion, and
the circumferential groove located on the outermost side in the tire width direction among the plurality of circumferential grooves in a range in which the circumferential reinforcing layer is disposed in the tire width direction,
a ratio Pd/Wd of a distance Pd in the tire radial direction between a position at which a tire equatorial plane intersects the tread contact surface and an opening portion center, which is a center of a groove width at a position of an opening portion of the circumferential groove with respect to the tread contact surface, to a distance Wd in the tire width direction from the tire equatorial plane to a position of the center of the groove width of the circumferential groove is 0.04 or less.

Aspect 9 includes the tire according to any one of Aspects [1] to [8], wherein the projection portion is disposed only on one of groove walls facing each other per position in an extension direction of the circumferential groove including the projection portion, and is disposed alternately in the extension direction of the circumferential groove with respect to the groove walls facing.

### REFERENCE SIGNS LIST

1 Pneumatic tire
2 Tread portion
3 Tread contact surface
5 Tread rubber
6 Shoulder portion
8 Sidewall portion
9 Sidewall rubber
10 Bead portion
11 Bead core
12 Bead filler
13 Carcass layer
14 Belt layer
142, 143 Cross belt layer
145 Circumferential reinforcing layer
17 Rim cushion rubber
16 Inner liner
20 Circumferential groove
21 Center main groove
22 Middle main groove
23 Shoulder main groove
25 Opening portion
26 Groove wall
27 Groove bottom
28 Projection portion
30 Land portion
31 Center land portion
32 First middle land portion
33 Second middle land portion
34 Shoulder land portion

What is claimed is:

1. A tire, comprising
a belt layer disposed in a tread portion and comprising a plurality of belt plies;
the belt layer comprising
a pair of cross-belt layers in which inclination directions of belt cords in a tire width direction with respect to a tire circumferential direction are opposite to each other; and,
a circumferential reinforcing layer in which an inclination angle of the belt cords in the tire width direction with respect to the tire circumferential direction is 5° or less;
the tread portion comprising at least one circumferential groove extending in the tire circumferential direction in a range in which the circumferential reinforcing layer is disposed in the tire width direction;
in at least one circumferential groove of the at least one circumferential groove, a projection portion projecting from a groove wall on at least one side into the circumferential groove and connected to a groove bottom being disposed;
in the circumferential groove comprising the projection portion, a road contact surface-side cross-sectional area S1, which is a cross-sectional area from a tread contact surface to a position corresponding to one-half of a groove depth of the circumferential groove, and a groove bottom-side cross-sectional area S2, which is a cross-sectional area from the position corresponding to one-half of the groove depth from the tread contact surface to the groove bottom, satisfying a relationship 0.1≤S2/S1≤0.7; and,
in the tread portion, a ratio D0/W0 of a thickness D0 from the tread contact surface to the circumferential reinforcing layer to a width W0 of the circumferential reinforcing layer in the tire width direction being defined as a deformation potential Tp of the tread portion, and the deformation potential Tp of the tread portion being within a range of 0.06≤Tp≤0.20.

2. The tire according to the claim 1, wherein in the at least one circumferential groove of the at least one circumferential groove, a deformation potential Gp of the circumferential groove calculated by multiplying the deformation potential Tp of the tread portion by an aspect ratio D1/W1 of the circumferential groove, which is a ratio of a groove depth D1 to a groove width W1 of the circumferential groove and dividing the resulting product by a position correction coefficient A of the circumferential groove derived from Formula A={Wd/(W0/2)}+1 . . . (1) using a distance Wd in the tire width direction from a tire equatorial plane to a center of a groove width of the circumferential groove and the width W0 in the tire width direction of the circumferential reinforcing layer is within a range 0.06≤Gp≤0.35.

3. The tire according to claim 1, wherein
a plurality of the circumferential groove are disposed in the tread portion; and,
the circumferential grooves each have a smallest ratio S2/S1 of the groove bottom-side cross-sectional area S2 to the road contact surface-side cross-sectional area S1 of the circumferential groove disposed at a position closest to a tire equatorial plane among the plurality of circumferential grooves.

4. The tire according to claim 1, wherein in the circumferential groove comprising the projection portion, a width W2 of the projection portion in a groove width direction of the circumferential groove and a groove width W1 of the circumferential groove satisfy a relationship 0.4≤W2/W1≤0.8.

5. The tire according to claim 1, wherein in the circumferential groove comprising the projection portion, a depth D2 of the projection portion in a groove depth direction of the circumferential groove and a groove depth D1 of the circumferential groove satisfy a relationship 0.2≤D2/D1≤0.6.

6. The tire according to claim 1, wherein in the circumferential groove comprising the projection portion, a distance d between the projection portion and a portion of the circumferential groove facing the projection portion in a groove width direction is within a range 1.0 mm≤d≤6.0 mm.

7. The tire according to claim 1, wherein the circumferential reinforcing layer is disposed between the pair of cross-belt layers and is formed to have a width in the tire width direction narrower than a width of the cross-belt layers.

8. The tire according to claim 1, wherein
a plurality of the circumferential groove are disposed in the tread portion;
in the circumferential groove located on the outermost side in the tire width direction among the plurality of the circumferential grooves in a range in which the circumferential reinforcing layer is disposed in the tire width direction; and,
a ratio Pd/Wd of a distance Pd in the tire radial direction between a position at which a tire equatorial plane intersects the tread contact surface and an opening portion center, which is a center of a groove width at a position of an opening portion of the circumferential groove with respect to the tread contact surface, to a distance Wd in the tire width direction from the tire equatorial plane to a position of the center of the groove width of the circumferential groove is 0.04 or less.

9. The tire according to claim 1, wherein the projection portion is disposed only on one of groove walls facing each other per position in an extension direction of the circumferential groove comprising the projection portion and is disposed alternately in the extension direction of the circumferential groove with respect to the groove walls facing.
